(19) United States
(12) Patent Application Publication
(10) Pub. No.: US 2008/0010175 A1
(43) Pub. Date: Jan. 10, 2008

(54) Accounting System, Accounting Method and Accounting Program

(75) Inventor: Takahiro Hagiwara, Chiba-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/277,224

(22) Filed: Mar. 22, 2006

(51) Int. Cl. G07F 17/00

(52) U.S. Cl. 705/30

(57) ABSTRACT

A technology for achieving an environment for use of an image processing apparatus meeting the needs of users is provided. An accounting system for carrying out accounting in accordance with an image process in an image processing apparatus comprises: a function use judging unit for judging whether a first function relating to the image process is used or not; a counting unit for counting the number of sheets processed with the first function in the case of judgment in the function use judging unit that the first function is used; and an accounting amount calculating unit for adding an extra charge to an accounting amount set for the case of processing sheets of the sheet processing number counted in the counting unit with the second function whose processing performance is lower than that of the first function at a predetermined ratio of addition corresponding to the first function.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION 1. Field of the Invention

The present invention relates to an accounting process for carrying out accounting in accordance with an image process in an image processing apparatus.

2. Description of the Related Art

The maximum processing speed in each function of an image processing apparatus capable of carrying out a process such as copying, scanning and printing is determined in advance before the apparatus arrives on the market. An image processing apparatus in which 20 sheets per a minute is set as the sheet processing performance, for example, is capable of copying, scanning and printing of 20 sheets per a minute at its maximum. On the other hand, an image processing apparatus in which 40 sheets per a minute is set as the sheet processing performance is capable of copying, scanning and printing of 40 sheets per a minute at its maximum. An MFP apparatus whose maximum processing speed is high (whose sheet processing performance per a unit time is high) requires advanced technology, and therefore, the selling price of the MFP apparatus is also high in general.

It is general to take introducing costs, running costs, frequency of use and the like into consideration totally before purchase when a user introduces an image processing apparatus since an image processing apparatus is expensive. Accordingly, low frequency of use typically causes a tendency of introduction of an MFP apparatus whose maximum processing speed is low. This, however, does not mean that the performance of an image processing apparatus whose processing speed is high is always not necessary. When occurrence of an urgent job temporally requires a large volume of copies although an image processing apparatus is usually used little, for example, a user is satisfied more with the MFP apparatus capable of processing 40 sheets per a minute since the MFP apparatus is shorter in processing time than an MFP apparatus capable of processing 20 sheets per a minute. Up to the present, however, an image processing apparatus whose maximum processing performance is changeable has not been sold.

The invention is to solve the above-mentioned problem. An object of the invention is to provide a technology for achieving an environment for use of an image processing apparatus, the environment meeting the needs of users.

### DESCRIPTION OF THE DRAWINGS

FIG. 1 is a functional block diagram illustrating an accounting system in accordance with the embodiment;

FIG. 2 is a simplified view for illustrating scanning and a path for carrying a printing sheet in an image processing apparatus 900;

FIG. 3 illustrates costs for introducing a typical image processing apparatus, which is determined on the basis of the printing speed;

FIG. 4 illustrates running costs for a typical image processing apparatus, which is determined on the basis of the printing speed;

FIG. 5 illustrates an example of a business model in accordance with the embodiment, the business model in which an image processing apparatus capable of changing the processing speed is combined with a new accounting system according to the processing speed;

FIG. 6 illustrates a ratio of addition;

FIG. 7 illustrates an extra charge;

FIG. 8 illustrates a conventional charge for use of printing;

FIG. 9 shows an input screen of a display unit 110 in setting a charge, which is a base of copying and printing operations;

FIG. 10 shows an example of a table of charges;

FIG. 11 shows an example of a screen for setting an extra charge;

FIG. 12 shows an example of a screen for setting an extra charge for scanning;

FIG. 13 shows an example of a table of extra charges;

FIG. 14 shows an example of a screen for operation in a copying process;

FIG. 15 shows an example of a screen for operation in a scanning process;

FIG. 16 shows an example of a screen for operation in a printing process;

FIG. 17 shows an example of a screen for displaying charges for use;

FIG. 18 shows an example of a table for setting authority of a user; and

FIG. 19 is a flowchart illustrating a flow of a process (an accounting method) in an accounting system in accordance with the embodiment.

### DETAILED DESCRIPTION OF THE INVENTION

Embodiments of the invention will be described hereinafter, made reference to the drawings.

Throughout this description, the embodiments and examples shown should be considered as exemplars, rather than limitations on the apparatus, methods and programs of the present invention.

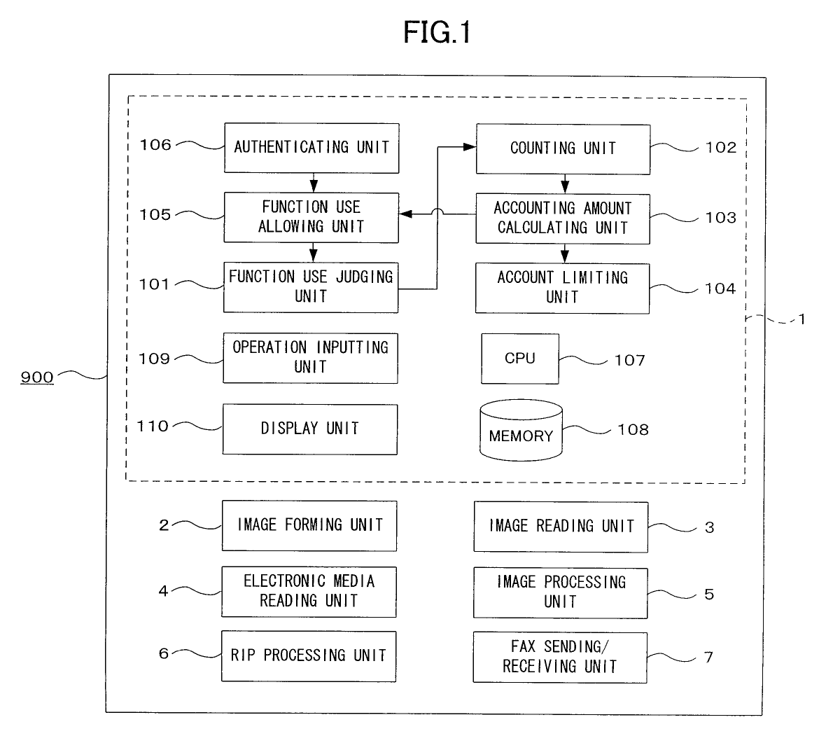

FIG. 1 is a functional block diagram illustrating an accounting system in accordance with the embodiment. The accounting system in accordance with the embodiment is provided in an image processing apparatus (an MFP: Multi Function Peripheral) 900, for example.

The image processing apparatus 900 in the embodiment comprises an accounting system 1, an image forming unit 2, an image reading unit 3, an electronic media reading unit 4, an image processing unit 5, an RIP processing unit 6 and a FAX sending/receiving unit 7.

The image reading unit 3 optically reads an original to generate image data. The FAX sending/receiving unit 7 compounds coded data sent through a public line and the like to generate image data. The RIP processing unit 6 interprets and renders a PDL (Page Description Language) sent from a network and the like to generate image data. The electronic media reading unit 4 reads image data from a memory card such as a CD-ROM and a compact flush. The image processing unit 5 converts the read image into image data capable of printing, adjusts the color, brightness, fineness and such and discriminates images to carry out conversion so that a better output of printing can be obtained in accordance with a result of the discrimination The image forming unit 2 prints the image data generated in the above-mentioned respective functional units on a sheet.

The accounting system 1 in accordance with the embodiment is an accounting system for carrying out accounting in accordance with an image process in the image processing apparatus 900. The accounting system 1 comprises a function use judging unit 101, a counting unit 102, an accounting amount calculating unit 103, an accounting limiting unit 104, a function use allowing unit 105, an authenticating unit 106, a CPU 107, a MEMORY 108, an operation inputting unit 109 and a display unit 110.

The function use judging unit 101 judges whether or not a first function related to an image process in the image processing apparatus 900 is used. The “first function” in the above context means an advanced function that an image processing apparatus only having standard processing performance (a second image processing apparatus) does not usually have. Concretely, the first function is a function including at least one of a predetermined data compression process by means of the image processing unit 5, an image reading process by means of the image reading unit 3 at a speed as fast as or faster than a predetermined speed, an image reading process with resolution as high as or higher than a predetermined resolution, an image reading process in color, an OCR process, a file generating process in a specific format by means of the image processing unit 5, a FAX sending/receiving process by means of the FAX sending/receiving unit 7 and a sheet carrying process at a speed as fast as or faster than a predetermined speed.

The function use judging unit 101 judges use of the first function on the basis of occurrence of an event in the image processing apparatus 900, log information, a counter value integrated in accordance with a process or the like. The function use judging unit 101 may also judge that the first function is used when a sheet processing speed in a predetermined process relating to an image process exceeds a predetermined speed.

The counting unit 102 counts the number of sheets processed with the first function in the case that the function use judging unit 101 judges that the first function is used.

The accounting amount calculating unit 103 adds an extra charge at a predetermined ratio of addition corresponding to the first function to an accounting amount set for the case of processing sheets of the sheet processing number counted by means of the counting unit 102 with a second function whose processing performance is lower than that of the first function.

The accounting limiting unit 104 changes a ratio of addition so that an additional amount to be added to the accounting amount by means of the accounting amount calculating unit 103 would not exceed a difference between introducing costs of a first image processing apparatus capable of normally using the first function (having an advanced function) and introducing costs of a second image processing apparatus capable of only using the second function.

The function use allowing unit 105 allows a predetermined user to use the first function when an extra charge added to the accounting amount by means of the accounting amount calculating unit 103 exceeds a difference between the introduction costs of the first image processing apparatus capable of normally using the first function and the introducing costs of the image processing apparatus 900 (the second image processing apparatus) capable of only using the second function. The predetermined user in the above context includes not only a specific user but also unspecified users.

The authenticating unit 106 authenticates a user using the image processing apparatus 900. The function use allowing unit 105 allows a user succeeded in completing an authentication process in the authenticating unit 106 to use the first function.

The CPU 107 has a role of performing various kinds of processes in the accounting system as well as a role of executing programs stored in the MEMORY 108 to achieve various functions. The MEMORY 108 comprises an HDD, a ROM, a RAM and such, for example, and has a role of storing various kinds of information and programs, which are used in the accounting system.

The operation inputting unit 109 comprises a key board, a mouse and the like and has a role of receiving an operation input from a user. The display unit 110 comprises a liquid crystal panel display, a CRT display or the like, for example, and has a role of carrying out image display of information relating to various kinds of processes in the image processing apparatus 900. The functions of the operation inputting unit 109 and the display unit 110 may be achieved by means of a touch panel display or the like, of course.

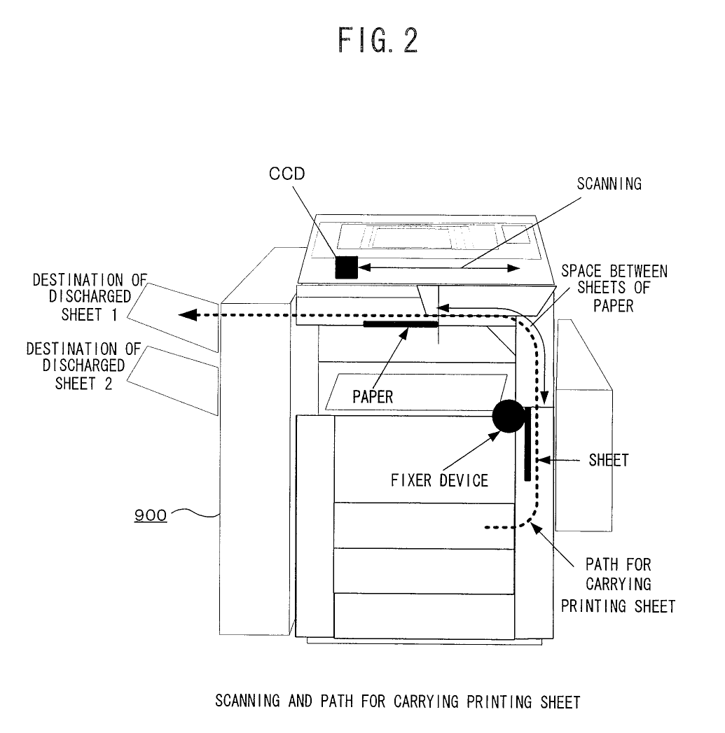

FIG. 2 is a simplified view for illustrating scanning and a path for carrying a printing sheet in the image processing apparatus 900. The maximum sheet processing speed of the image reading unit 3 is determined in accordance with performance of a CCD for reading an image, performance of a carrying device for moving an original or a CCD device or the like. The maximum sheet processing speed of the image forming unit 2 is determined in accordance with performance of a fixer device for fixing a printing image on paper and performance of a carrying device for moving a sheet. The maximum sheet processing speed in copying is generally determined in accordance with the slower maximum processing speed between the image reading unit 3 and the image forming unit 2. Changing the performance of the above devices allows the maximum processing speed of the image processing apparatus to be changeable. For example, changing the carrying speed of the carrying device allows the maximum processing speed of the image reading unit 3 to be changed. Changing the voltage of a used servo motor or frequency of a pulse motor allows a change in carrying speed to be controlled. In the case of the image forming unit 2, making a space between sheets in sending the sheets narrow or wide allows the maximum processing speed to be changed. It is difficult to make the performance of the CCD and the fixer device changeable in view of a matter of costs or the like. Accordingly, this is achieved by using a device capable of processing the maximum value of processing performance, which can be assumed. As described above, it can be seen that the processing performance of mechanical components in an image processing apparatus can be made changeable.

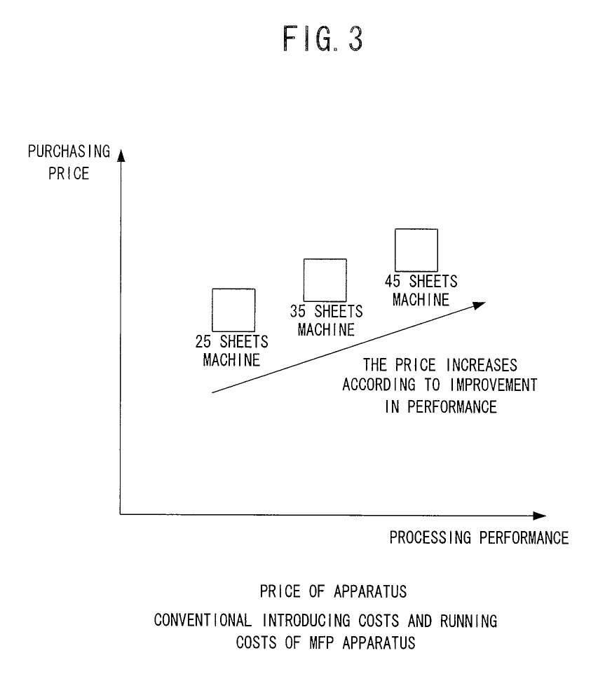

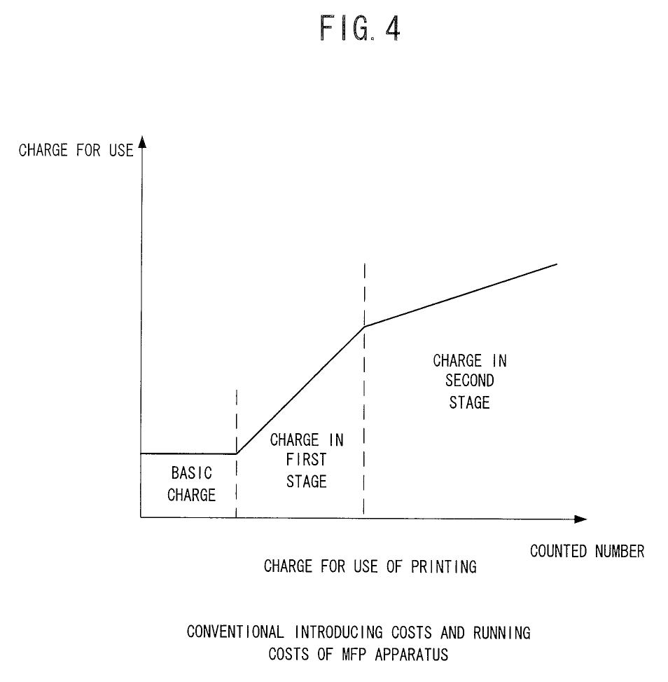

FIG. 3 illustrates costs for introducing a typical image processing apparatus, which is determined on the basis of the printing speed. FIG. 4 illustrates running costs for a typical image processing apparatus, which is determined on the basis of the printing speed. The image processing apparatus whose printing speed is high (45 sheets machine, for example) costs more in introduction than the image processing apparatus whose printing speed is low (25 sheets machine, for example). On the other hand, as for the running costs, a charge is determined in accordance with quantity of printed pages regardless of the printing speed. This means that the running costs do not depend on the processing speed of the image processing apparatus. In the above context, the 45 sheets machine means an image processing apparatus capable of performing an image forming process for 45 sheets per a minute.

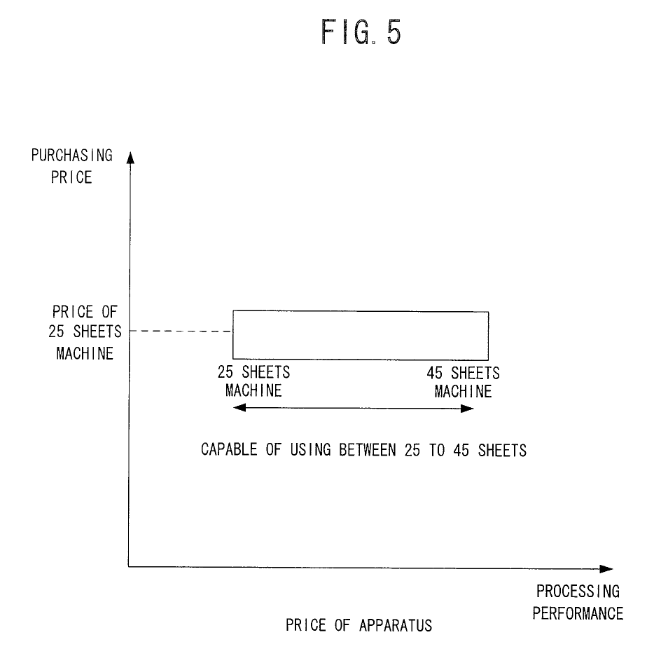

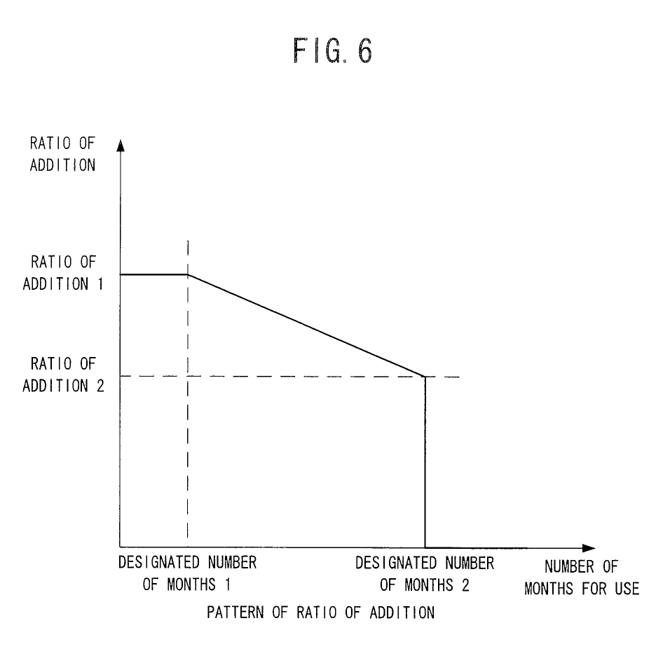

FIG. 5 illustrates an example of a business model in accordance with an embodiment, the business model in which an image processing apparatus capable of changing the processing speed is combined with a new accounting system according to the processing speed. As for the introducing costs of an image processing apparatus (FIG. 5), a user is supplied with an image processing apparatus at a price equal to that of the image processing apparatus of 25 sheets per a minute, which is the most inexpensive model in a series of image processing apparatuses, regardless of the maximum processing speed of the image processing apparatus. At that time, a standard mode the user can use without paying an additional charge (an extra charge) is a mode in which the processing speed is 25 sheets per a minute. The user can also use a high-performance mode in which the processing speed is temporally increased to 45 sheets per a minute by paying an additional charge, which is obtained by multiplying a standard charge by a ratio of addition (FIG. 6).

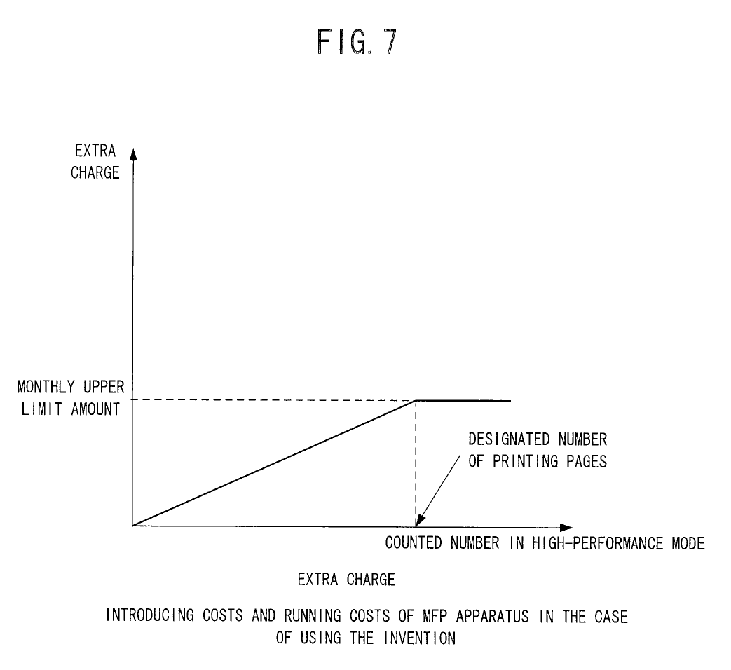

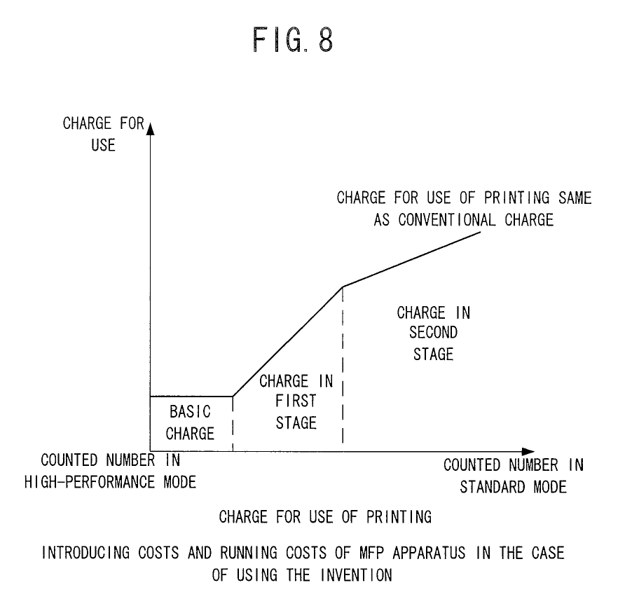

The extra charge (FIG. 7) is calculated in accordance with the counted number in a use of the high-performance mode. The extra charge is characterized by usually increasing in proportion to the counted number but not being added when the counted number exceeds a designated print-counting number set in advance. That is to say, the extra charge for a month is only charged up to the upper limit charge for a month. This is for preventing the sum of the expense for introducing the apparatus and the extra charges from exceeding the introducing price of an upper-grade apparatus since an object of the extra charge is to complement a difference in purchasing price (a difference in introducing price) between the purchased apparatus and the upper-grade apparatus. The user pays the amount, which is the sum of the extra charge and a conventional charge for using the printing function (FIG. 8), as a rental fee.

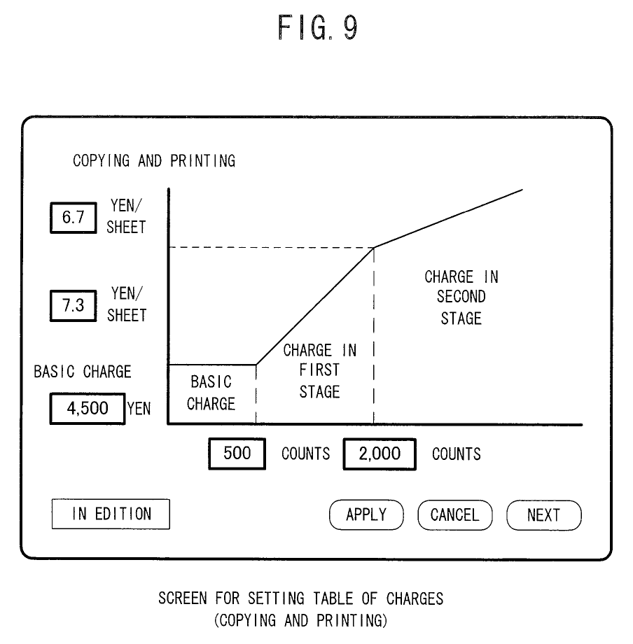

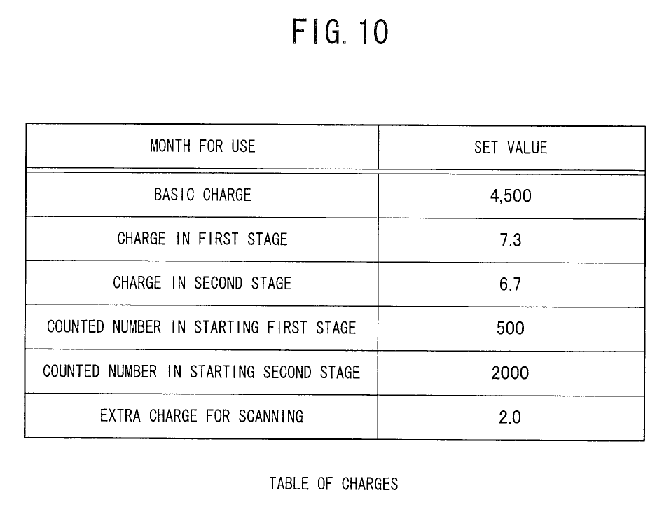

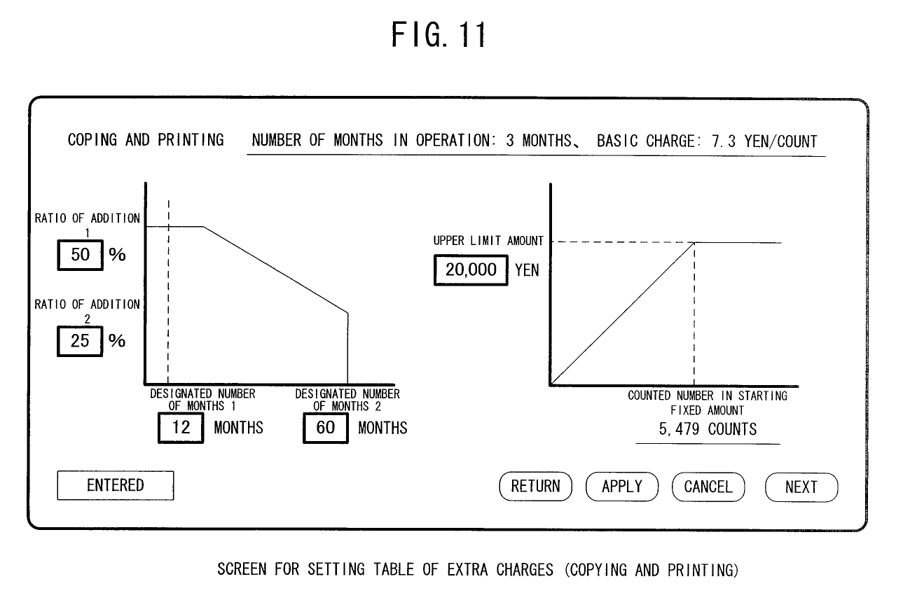

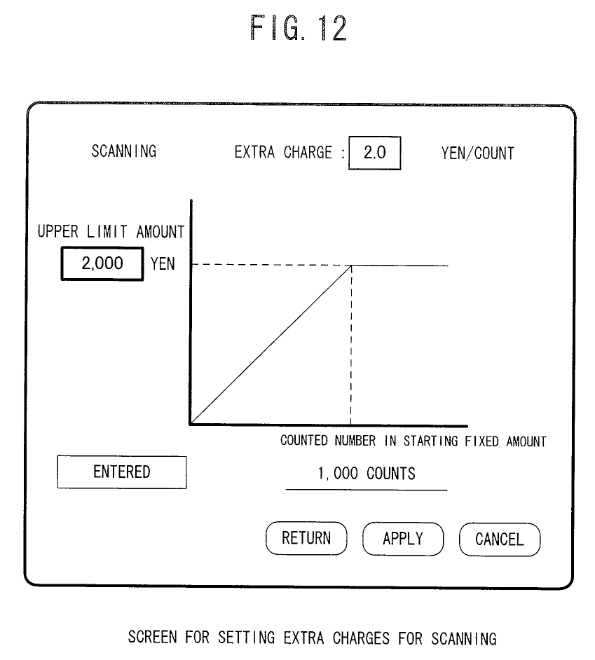

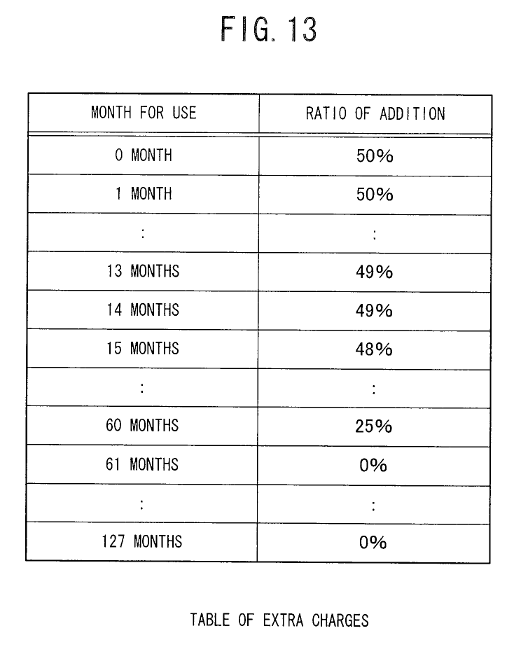

Now, an accounting system newly required to an image processing apparatus in order to achieve the above-mentioned business model will be described. FIG. 9 shows an input screen of a display unit 110 in setting a charge, which is a base of copying and printing operations. Values are usually inputted in advance in shipping, but can be changed by a maintenance person in accordance with necessity. “IN EDITION” is displayed in editing the values on the screen to indicate that the values on the screen are not reflected in setting. The display is changed into “ENTERED” when a button “APPLY” or “CANCEL” is depressed so as to indicate that the displayed values are reflected in setting. Depressing a button “NEXT” after entering “BASIC CHANGE”, “CHARGE IN FIRST STAGE”, “CHARGE IN SECOND STAGE”, “COUNTED NUMBER IN STARTING IN FIRST STAGE” and “COUNTED NUMBER IN STARTING IN SECOND STAGE” allows the values to be recorded in “TABLE OF CHARGES” in FIG. 10 and the screen to be switched into the input screen for setting extra charges (FIG. 11). A maintenance person sets values of “RATIO OF ADDITION 1”, “RATIO OF ADDITION 2”, “DESIGNATED NUMBER OF MONTHS 1”, “DESIGNATED NUMBER OF MONTHS 2” and “UPPER LIMIT AMOUNT” in bold-line frames on the screen as well as setting a table of charges. “COUNTED NUMBER IN STARTING FIXED AMOUNT” is recalculated to renew the display after the values are inputted. When the displayed “COUNTED NUMBER IN STARTING FIXED AMOUNT” is proper, the button “APPLY” is depressed to enter setting of the extra charges. The button “CANCEL” is depressed in the case of returning to the original setting values while a button “RETURN” is depressed to reset each parameter in the case of changing the values in the table of charges. Depressing the button “NEXT” after setting for the copying and printing operations are completed allows the screen to be switched into a screen for setting an extra charge in scanning (refer to FIG. 12). Usually, set is an extra charge, which is to be added only in the case of performing value-added scanning, since scanning is not charged. FIG. 13 shows an example of a table of extra charges. A value-added function here includes scanning speed, high-resolution scanning, color scanning in a monochrome machine, OCR scanning, filing into a specific format (such as a high-compression PDF) and the like. Setting “EXTRA CHARGE” and “UPPER LIMIT AMOUNT”, confirming that “COUNT IN STARTING FIXED AMOUNT” is a proper value and depressing a button “APPLY” allow setting to be completed.

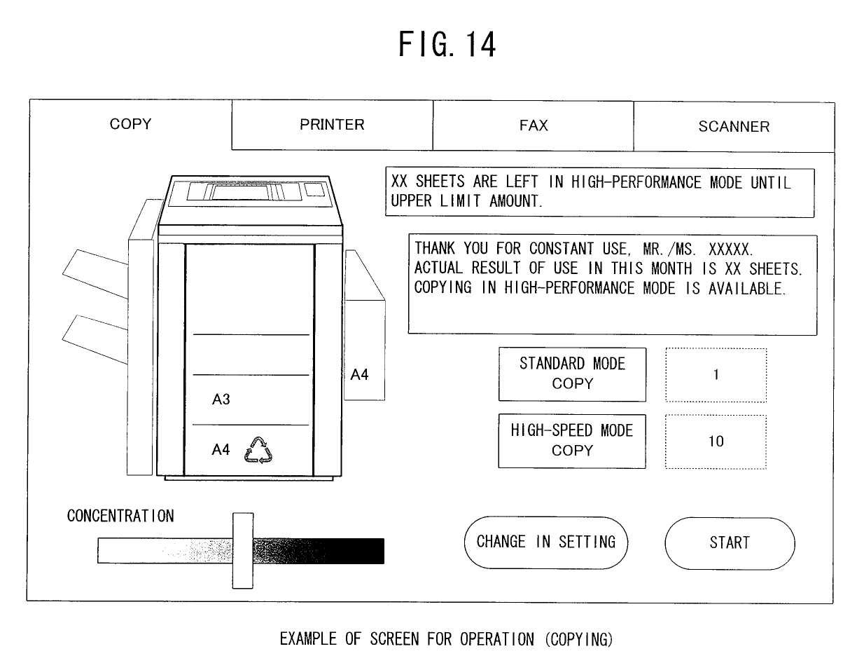

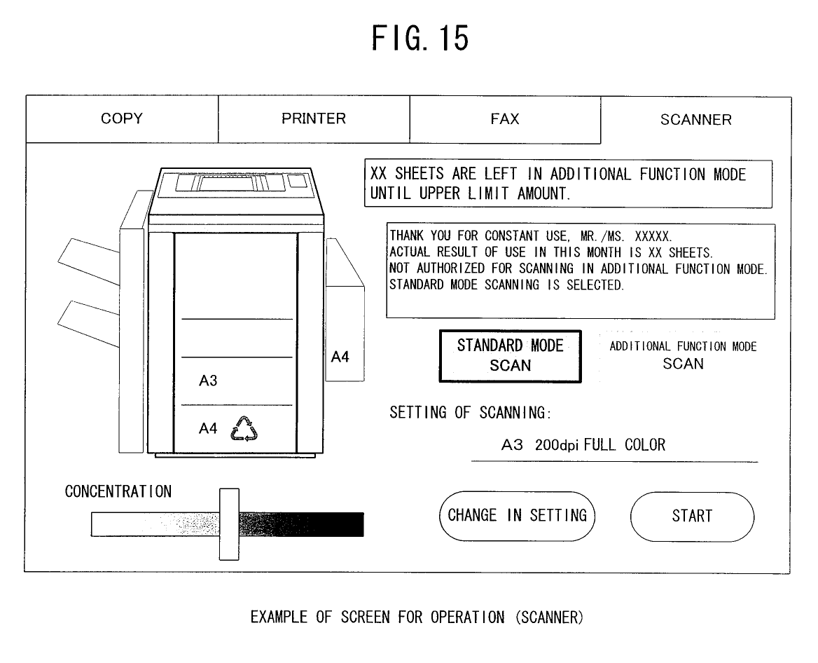

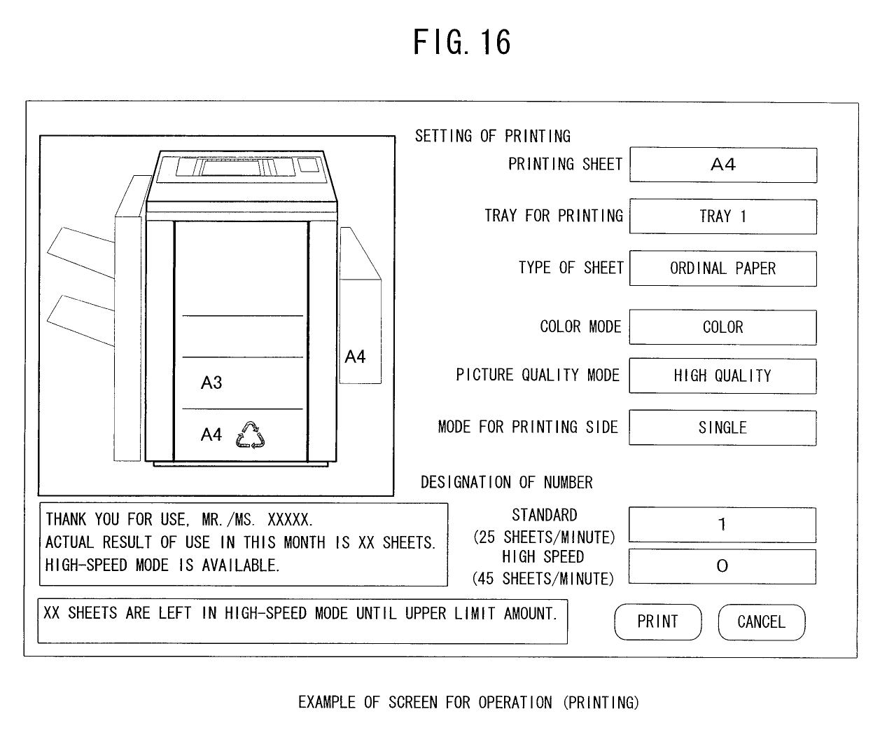

Now, described will be operational screens for copying (FIG. 14), scanning (FIG. 15) and printing (FIG. 16) operations. On the screen, displayed is a remaining count until the extra charge reaches the fixed amount in the copying operation. The authentication of a user is used for indicating authority to use the high-speed mode. Capability of designating the number of copies with the standard mode and the high-speed mode being mixed is characteristic. Similarly, a remaining count until the extra charge reaches the fixed amount is displayed on the screen in the scanning operation. Using the authentication of a user for indicating authority to use the high-speed mode is characteristic. As for a printer, a remaining count until the extra charge reaches the fixed amount is displayed on a UI screen of a printer driver displayed on the PC. The authentication of a user is used for indicating authority to use the high-speed mode. Capability of designating the number of copies with the standard mode and the high-speed mode being mixed is characteristic.

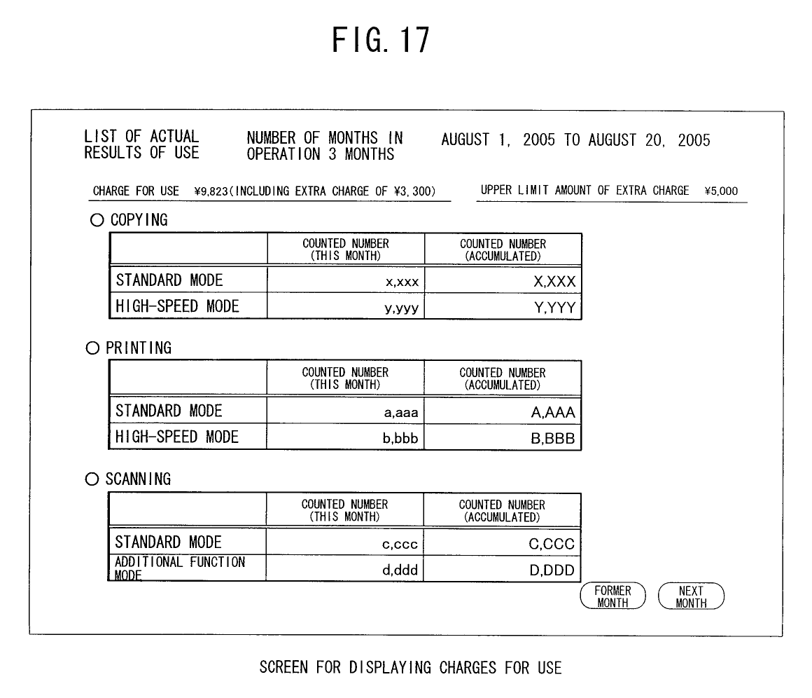

FIG. 17 shows a screen for displaying charges for use. The screen indicates the numbers counted for use in the standard, high-speed and additional function modes for every function for every month and the accumulated numbers thereof as well as a charge for use, an extra charge and an upper limit amount of the extra charge for every month.

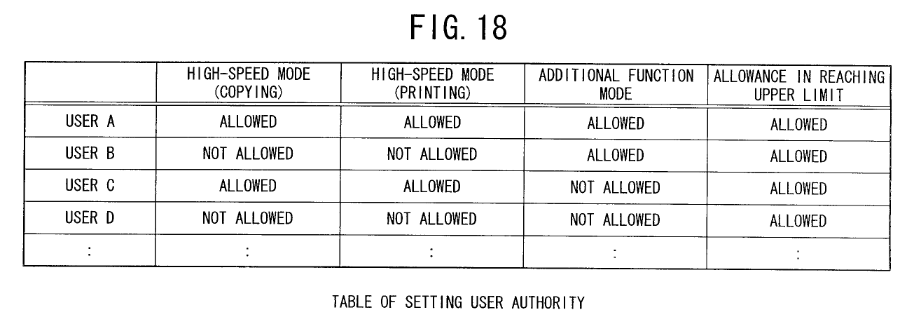

It is also possible to confirm actual results of past use and the upper limit amount of the extra charge for a future month by means of buttons “FORMER MONTH and “NEXT MONTH” In an image processing apparatus having a function of user authentication, using a table for setting authority of a user, which is shown in FIG. 18, allows limitation of use of the high-speed mode, additional function mode for each user to be achieved and allowance of use of the high-speed mode and additional function mode (the first function) for all or designated users to be automatically set when the extra charge reaches the upper limit amount of the extra charge.

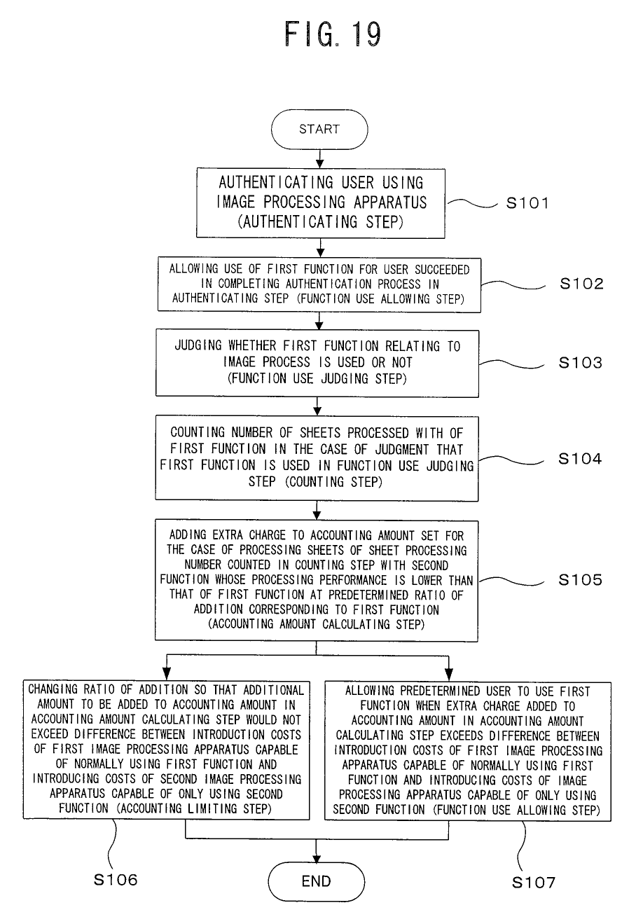

FIG. 19 is a flowchart illustrating a flow of a process (an accounting method) in an accounting system in accordance with the embodiment.

The authenticating unit 106 authenticates a user using an image processing apparatus (in an authenticating step) (S101).

The function use allowing unit 105 allows use of the first function for a user succeeded in completing an authentication process in the authenticating step (in a function use allowing step) (S102).

The function use judging unit 101 judges whether the first function relating to an image process is used or not (in a function use judging step) (S103). In the function use judging step, it may be possible to judge that the first function is used when the sheet processing speed in a predetermined process relating to the image process exceeds a predetermined speed.

The counting unit 102 counts the number of sheets processed with the first function in the case of judgment that the first function is used in the function use judging step (in a counting step) (S104).

The accounting amount calculating unit 103 adds an extra charge to an accounting amount set for the case of processing sheets of the sheet processing number counted in the counting step with the second function whose processing performance is lower than that of the first function at a predetermined ratio of addition corresponding to the first function (in an accounting amount calculating step) (S105).

The accounting limiting unit 104 changes a ratio of addition so that an additional amount to be added to the accounting amount in the accounting amount calculating step would not exceed a difference between introduction costs of a first image processing apparatus capable of normally using the first function and introducing costs of a second image processing apparatus capable of only using the second function (in an accounting limiting step) (S106).

The function use allowing unit 105 allows a predetermined user to use the first function when an extra charge added to the accounting amount in the accounting amount calculating step exceeds a difference between the introduction costs of the first image processing apparatus capable of normally using the first function (the selling price of the first image processing apparatus, for example) and the introducing costs of the second image processing apparatus capable of only using the second function (the selling price of the second image processing apparatus, for example) (in a function use allowing step) (S107).

The respective steps in the process (the accounting method) in the above-mentioned accounting system can be achieved when the CPU 107 is made to execute an accounting program stored in the MEMORY 108.

In the embodiment, exemplified is a case that all components forming the accounting system are provided in the image processing apparatus. The locations where the components forming the accounting system in the embodiment are provided, however, are not limited so long as all the components are provided so as to be capable of communicating with each other as a result.

Providing the accounting system in the embodiment and the speed controlling unit for controlling a sheet processing speed in a predetermined image process in an image processing apparatus allows an image processing apparatus in which the accounting system described above is effective to be provided

As described above, in accordance with the embodiments, a user can introduce an image processing apparatus at a lower price and is only required to pay an extra charge for actual use of a necessary function. Further, an upper limit price is set for the extra charge, and therefore, the sum of the extra charges do not exceed the introduction costs for purchasing an upper-grade machine even when the high-speed mode or the additional function mode is used, so that an appropriate accounting process can be performed for a user.

In the embodiment, described is a case that the function for carrying out the invention is recorded in advance in the apparatus. The invention, however, is not limited to the above. A similar function may be downloaded from a network to the apparatus or a similar function stored in a recording medium may be installed in the apparatus. The recording medium can be in any forms such as a CD-ROM, for example, so long as it can store a program and be read by the apparatus. The function installed in advance or obtained by download as described above may cooperate with an OS (Operating System) in the apparatus or the like to be achieved.

The invention has been described in a specific mode in detail. It would be obvious, however, for a person skilled in the art that various kinds of modification and alternation can be considered as long as they are not deviated from the spirit and scope of the invention.

As described above in detail, in accordance with the invention, a technology for achieving an environment for use of an image processing apparatus meeting the needs of users can be provided.

It is claimed:

1. An accounting system for carrying out accounting in accordance with an image process in an image processing apparatus, comprising:
a function use judging unit that judges whether a first function relating to the image process is used or not;
a counting unit that counts the number of sheets processed with the first function in the case of judgment in the function use judging unit that the first function is used; and
an accounting amount calculating unit that adds an extra charge to an accounting amount set for the case of processing sheets of the sheet processing number counted in the counting unit with the second function whose processing performance is lower than that of the first function at a predetermined ratio of addition corresponding to the first function.

2. The accounting system according to claim 1, wherein
the function use judging unit judges that the first function is used when a sheet processing speed in a predetermined process relating to an image process exceeds a predetermined speed.

3. The accounting system according to claim 1, wherein
the first function includes at least one of a sheet carrying process at a speed as fast as or faster than a predetermined speed, a predetermined data compression process, an image reading process at a speed as fast as or faster than a predetermined speed, an image reading process with resolution as high as or higher than a predetermined resolution, an image reading process in color, an OCR process and a file generating process in a specific format.

4. The accounting system according to claim 1, comprising
an accounting limiting unit that changes the ratio of addition so that an additional amount to be added to the accounting amount in the accounting amount calculating unit would not exceed a difference between introducing costs of a first image processing apparatus capable of normally using the first function and introducing costs of a second image processing apparatus capable of only using the second function.

5. The accounting system according to claim 1, comprising
a function use allowing unit that allows a predetermined user to use the first function when an extra charge added to the accounting amount in the accounting amount calculating unit exceeds a difference between the introduction costs of a first image processing apparatus capable of normally using the first function and the introducing costs of a second image processing apparatus capable of only using the second function.

6. The accounting system according to claim 1, comprising:
an authenticating unit for authenticating a user using the image processing apparatus; and
a function use allowing unit for allowing a user succeeded in completing an authentication process in the authenticating unit to use the first function.

7. An accounting method for carrying out accounting in accordance with an image process in an image processing apparatus, comprising:
a function use judging step for judging whether a first function relating to the image process is used or not;
a counting step for counting the number of sheets processed with the first function in the case of judgment in the function use judging step that the first function is used; and
an accounting amount calculating step for adding an extra charge to an accounting amount set for the case of processing sheets of the sheet processing number counted in the counting step with the second function whose processing performance is lower than that of the first function at a predetermined ratio of addition corresponding to the first function.

8. The accounting method according to claim 7, wherein
in the function use judging step, it is judged that the first function is used when a sheet processing speed in a predetermined process relating to an image process exceeds a predetermined speed.

9. The accounting method according to claim 7, wherein
the first function includes at least one of a sheet carrying process at a speed as fast as or faster than a predetermined speed, a predetermined data compression process, an image reading process at a speed as fast as or faster than a predetermined speed, an image reading process with resolution as high as or higher than a predetermined resolution, an image reading process in color, an OCR process and a file generating process in a specific format.

10. The accounting method according to claim 7, comprising
an accounting limiting step for changing the ratio of addition so that an additional amount to be added to the accounting amount in the accounting amount calculating step would not exceed a difference between introducing costs of a first image processing apparatus capable of normally using the first function and introducing costs of a second image processing apparatus capable of only using the second function.

11. The accounting method according to claim 7, comprising
a function use allowing step for allowing a predetermined user to use the first function when an extra charge added to the accounting amount in the accounting amount calculating step exceeds a difference between the introduction costs of a first image processing apparatus capable of normally using the first function and the introducing costs of a second image processing apparatus capable of only using the second function.

12. The accounting method according to claim 7, comprising:
an authenticating step for authenticating a user using the image processing apparatus; and
a function use allowing step for allowing a user succeeded in completing an authentication process in the authenticating step to use the first function.

13. An accounting program for carrying out accounting in accordance with an image process in an image processing apparatus, the accounting program for a computer to execute:
a function use judging step for judging whether a first function relating to the image process is used or not;
a counting step for counting the number of sheets processed with the first function in the case of judgment in the function use judging step that the first function is used; and
an accounting amount calculating step for adding an extra charge to an accounting amount set for the case of processing sheets of the sheet processing number counted in the counting step with the second function whose processing performance is lower than that of the first function at a predetermined ratio of addition corresponding to the first function.

14. The accounting program according to claim 13, wherein
in the function use judging step, it is judged that the first function is used when a sheet processing speed in a predetermined process relating to an image process exceeds a predetermined speed.

15. The accounting program according to claim 13, wherein
the first function includes at least one of a sheet carrying process at a speed as fast as or faster than a predetermined speed, a predetermined data compression process, an image reading process at a speed as fast as or faster than a predetermined speed, an image reading process with resolution as high as or higher than a predetermined resolution, an image reading process in color, an OCR process and a file generating process in a specific format.

16. The accounting program according to claim 13, comprising
an accounting limiting step for changing the ratio of addition so that an additional amount to be added to the accounting amount in the accounting amount calculating step would not exceed a difference between introducing costs of a first image processing apparatus capable of normally using the first function and introducing costs of a second image processing apparatus capable of only using the second function.

17. The accounting program according to claim 13, comprising
a function use allowing step for allowing a predetermined user to use the first function when an extra charge added to the accounting amount in the accounting amount calculating step exceeds a difference between the introduction costs of a first image processing apparatus capable of normally using the first function and the introducing costs of a second image processing apparatus capable of only using the second function.

18. The accounting program according to claim 13, comprising:
an authenticating step for authenticating a user using the image processing apparatus; and
a function use allowing step for allowing a user succeeded in completing an authentication process in the authenticating step to use the first function.
